(19) United States
(12) Patent Application Publication
(10) Pub. No.: US 2025/0136146 A1
(43) Pub. Date: May 1, 2025

(54) AUTOMATED DRIVING SYSTEM

(71) Applicant: Mitsubishi Electric Corporation, Tokyo (JP)

(72) Inventors: Michitoshi AZUMA, Tokyo (JP); Toru Higuchi, Tokyo (JP); Takayuki Tanaka, Tokyo (JP); Kohei Mori, Tokyo (JP)

(73) Assignee: Mitsubishi Electric Corporation, Tokyo (JP)

(21) Appl. No.: 18/816,136

(22) Filed: Aug. 27, 2024

(30) Foreign Application Priority Data
Oct. 25, 2023 (JP) 2023-182997

(51) Int. Cl. B60W 60/00; B60W 30/095; B60W 30/18; G08G 1/01; G08G 1/056; G08G 1/0967; G08G 1/16; H04W 4/44

(52) U.S. Cl. CPC B60W 60/001; B60W 30/0956; B60W 30/18018; G08G 1/0116; G08G 1/056; G08G 1/096725; G08G 1/164; G08G 1/166; H04W 4/44; B60W 2420/50; B60W 2520/14; B60W 2554/4044; B60W 2556/20; B60W 2556/40; B60W 2556/45

(57) ABSTRACT

This automated driving system includes a vehicle having a target traveling path for performing automated traveling, the automated driving system being configured to acquire a position and an azimuth of the vehicle and a measurement reliability therefor. The vehicle includes an automated traveling restart determination unit for switching from a stopped state to automated traveling. In a case where the measurement reliability is equal to or greater than a predetermined first threshold, restart of automated traveling of the vehicle is permitted when an absolute value of a first position deviation between the target traveling path and the position of the vehicle is equal to or smaller than a predetermined second threshold and an absolute value of an angle deviation between an azimuth of the target traveling path and the azimuth of the vehicle is equal to or smaller than a predetermined third threshold.

### BACKGROUND OF THE INVENTION

### 1. Field of the Invention

The present disclosure relates to an automated driving system.

### 2. Description of the Background Art

In recent years, in the field of mobility, information communication technologies such as big data and a fifth-generation mobile communication system (5G), as well as advanced technologies such as artificial intelligence (AI), have been increasingly introduced, and along with advancement of these technologies, automation of transportation of humans and products is being actively developed. Thus, solutions for various social problems, e.g., solution for a last-mile problem, solution for shortage of drivers in the physical distribution field, and relaxation of traffic congestion, which would be conventionally difficult, are expected.

In addition, for example, in vehicle running in a factory, a driver has conventionally transported a product from a specific point to another point, using a truck or a towing cart. However, in order to improve the operation rate of the factory, it is necessary to constantly perform transportation in the factory. However, for this purpose, it is necessary to make solution such as increasing the number of vehicles capable of towing or increasing transportation time periods, thus causing problems such as increase in equipment cost and increase in labor cost due to addition of drivers. Accordingly, for reducing such burdens, automated driving or unmanned driving of a transportation vehicle is required.

In automated driving technology, technology levels applied to general vehicles are defined by the Society of Automotive Engineers (SAE) in the US, i.e., at automated driving levels 0 to 3, a driver needs to monitor a vehicle, and at an automated driving level 4 and higher, automated traveling can be continued without a driver monitoring a vehicle.

In order to implement an automated driving system at the automated driving level 4 or higher, in many vehicles, it is necessary to perform traveling while ensuring safety with sensors mounted, e.g., by a front camera for monitoring a front side of a vehicle, monitoring for frontward and rearward obstacles using millimeter-wave radar sensors (MMWR), distance measurement for a surrounding obstacle using point-cloud information from optical sensors (light detection and ranging sensors (LiDAR)), and measurement of a distance to an obstacle using an ultrasonic sensor.

However, even if such sensors are mounted, there is still a blind spot due to limits of fields of view (FoV) of the sensors. In addition, mounting such sensors to a vehicle increases sensor cost. Further, as an increased number of automated driving vehicles travel, which automated driving vehicle should be prioritized cannot be determined without a priority order of traveling vehicles, thus causing such a problem that both vehicles stop. In order to solve such a problem, an automated driving system for making adjustment between automated driving vehicles is also being developed using a roadside unit (RSU), a multi-access edge computer (MEC), 5G technology, and the like.

Further, there is also a satellite-utilized automated driving system based on positioning information from an artificial satellite. In this system, a vehicle receives positioning information such as a vehicle position and a vehicle azimuth from a global navigation satellite system (GNSS) including a quasi-zenith satellite, and performs traveling so as to follow a specified traveling route, while reducing a deviation between the own-vehicle position and the traveling path. With such a system provided, it becomes possible to perform automated traveling in an outdoor area, so that efficient transportation of humans and products is being achieved.

Whether a stopped vehicle can smoothly restart automated driving is also an important problem and a method therefor is disclosed (see, for example, Patent Document 1).
Patent Document 1: Japanese Laid-Open Patent Publication No. 2021-163268

In Patent Document 1, traveling is determined to be restarted when a position deviation and an angle deviation of the own vehicle from a traveling path are equal to or smaller than thresholds. However, in the system disclosed in Patent Document 1, for example, in a use case where a main switch is turned from off to on, received information from a GNSS is reset, so that the vehicle position and the vehicle azimuth become uncertain. Therefore, the vehicle position and the vehicle azimuth need to be measured again. In an environment in which a signal can be received from the GNSS, the vehicle position can be measured by the vehicle waiting for a certain period without movement of the vehicle. However, the vehicle azimuth cannot be moved without movement of the vehicle. Therefore, if automated traveling is restarted in this state, there is a risk of traveling in a direction deviating from the traveling path, depending on the orientation angle of the vehicle. Therefore, intervention of manual driving is needed until the vehicle azimuth is measured, and thus the system requires frequent intervention of a user.

### SUMMARY OF THE INVENTION

The present disclosure has been made to solve the above problem, and an object of the present disclosure is to provide an automated driving system that enables automated driving to be smoothly restarted while being less intervened by a user.

An automated driving system according to the present disclosure is an automated driving system including a vehicle having a target traveling path for performing automated traveling, the automated driving system being configured to acquire a position and an azimuth of the vehicle and a measurement reliability therefor. The vehicle includes an automated traveling restart determination unit for switching from a stopped state to automated traveling. In a case where the measurement reliability is equal to or greater than a predetermined first threshold, restart of automated traveling of the vehicle is permitted when an absolute value of a first position deviation between the target traveling path and the position of the vehicle is equal to or smaller than a predetermined second threshold and an absolute value of an angle deviation between an azimuth of the target traveling path and the azimuth of the vehicle is equal to or smaller than a predetermined third threshold.

According to the present disclosure, it becomes possible to provide an automated driving system that enables automated driving to be smoothly restarted while being less intervened by a user.

### BRIEF DESCRIPTION OF THE DRAWINGS

FIG. 1 is a block diagram showing a configuration of an automated driving system according to the first embodiment of the present disclosure;

FIG. 2A shows an example of a hardware configuration of a multi-access edge computer (MEC) according to the first embodiment;

FIG. 2B shows an example of a hardware configuration of a roadside unit (RSU) according to the first embodiment;

FIG. 2C shows an example of a hardware configuration of a vehicle that performs automated driving according to the first embodiment;

FIG. 3 is a function block diagram showing a configuration of the roadside unit (RSU) according to the first embodiment;

FIG. 4A is a function block diagram showing a configuration of a vehicle that performs automated driving according to the first embodiment;

FIG. 4B is a function block diagram showing a configuration of an automated traveling restart determination unit of an AD module mounted to a vehicle;

FIG. 5 shows transition of a vehicle state of the vehicle that performs automated driving according to the first embodiment;

FIG. 6A is a flowchart showing operation for restarting automated driving of the vehicle in the automated driving system according to the first embodiment;

FIG. 6B is a flowchart showing operation for restarting automated driving of the vehicle in the automated driving system according to the first embodiment;

FIG. 6C is a flowchart showing operation for restarting automated driving of the vehicle in the automated driving system according to the first embodiment;

FIG. 7 is a function block diagram showing a configuration of a vehicle azimuth determination unit included in a multi-access edge computer (MEC);

FIG. 8A shows a setting example of a reliability in the automated driving system according to the first embodiment;

FIG. 8B shows another setting example of a reliability in the automated driving system according to the first embodiment;

FIG. 9 shows an example of a list of azimuths of a stopped vehicle and reliabilities therefor, included in the multi-access edge computer (MEC);

FIG. 10 illustrates operation for restarting automated driving of the vehicle in the automated driving system according to the first embodiment;

FIG. 11A illustrates a traveling path for a vehicle in an automated driving system according to the second embodiment of the present disclosure; and

FIG. 11B illustrates the traveling path for the vehicle in the automated driving system according to the second embodiment.

### DETAILED DESCRIPTION OF THE PREFERRED

### Embodiments of the Invention

Hereinafter, embodiments of an automated driving system according to the present disclosure will be described with reference to the drawings. In the drawings, the same reference characters denote the same or corresponding parts. Therefore, the detailed description thereof may be omitted for the purpose of avoiding redundancy.

### First Embodiment

Hereinafter, an automated driving system according to the first embodiment of the present disclosure will be described with reference to the drawings.

### <Entire Configuration of Automated Driving System>

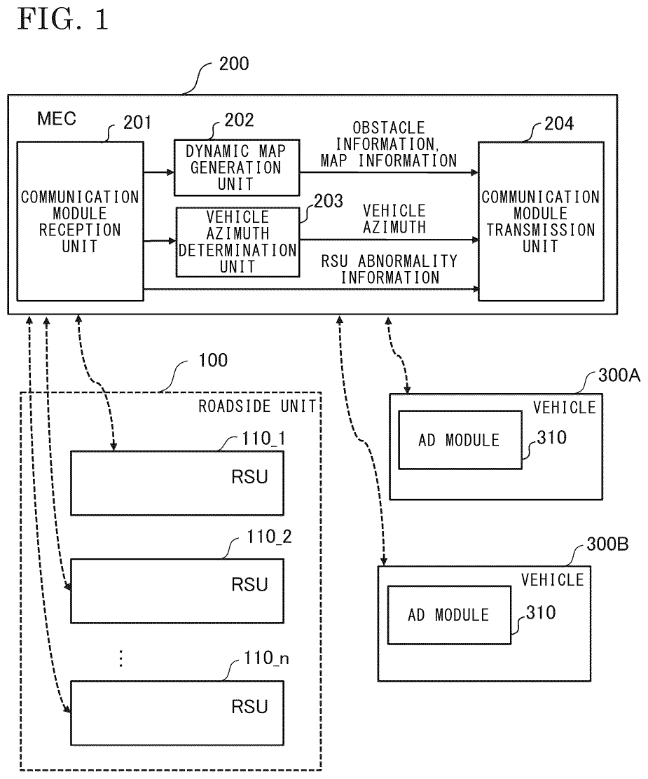

FIG. 1 is a block diagram showing a configuration of an automated driving system according to the first embodiment. In FIG. 1, the automated driving system is an infrastructure-based automated driving system including a roadside unit group 100 including roadside units (hereinafter, referred to as RSUs) 110_1, . . . 110_n, a multi-access edge computer (hereinafter, referred to as MEC) 200, and a vehicle 300A and a vehicle 300B each provided with an automated driving (AD) module (hereinafter, referred to as AD module).

When the RSUs are collectively mentioned, they are referred to as RSUs 110. Here, a case where there are two vehicles that perform automated driving will be described, but the number of the vehicles is not limited to two.

Normally, communication between each RSU 110 and the MEC 200 is performed through a wireless network such as long term evolution (LTE) or 5G, or another dedicated network. Similarly, communication between the MEC 200 and each vehicle 300A, 300B is also performed through a high-speed and low-latency wireless network such as LTE or 5G, or another dedicated network.

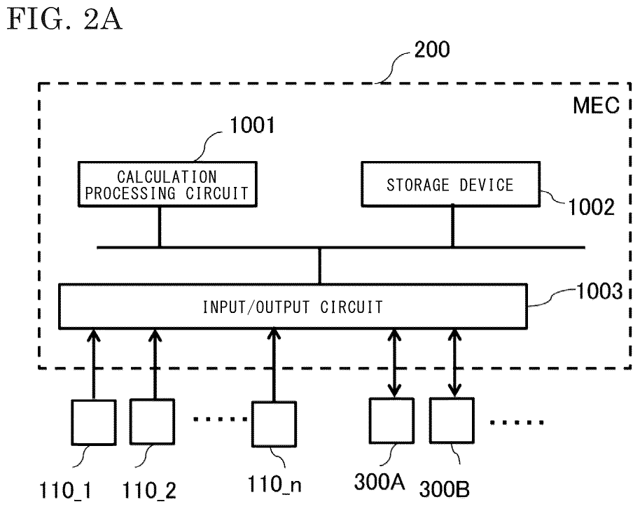

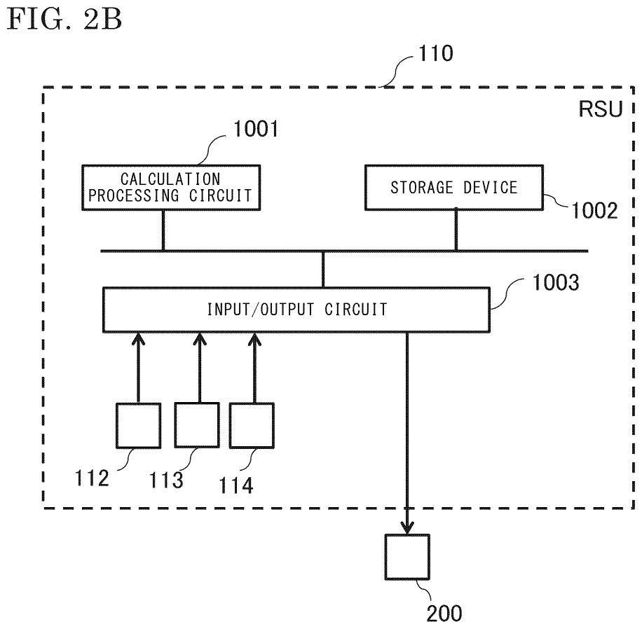

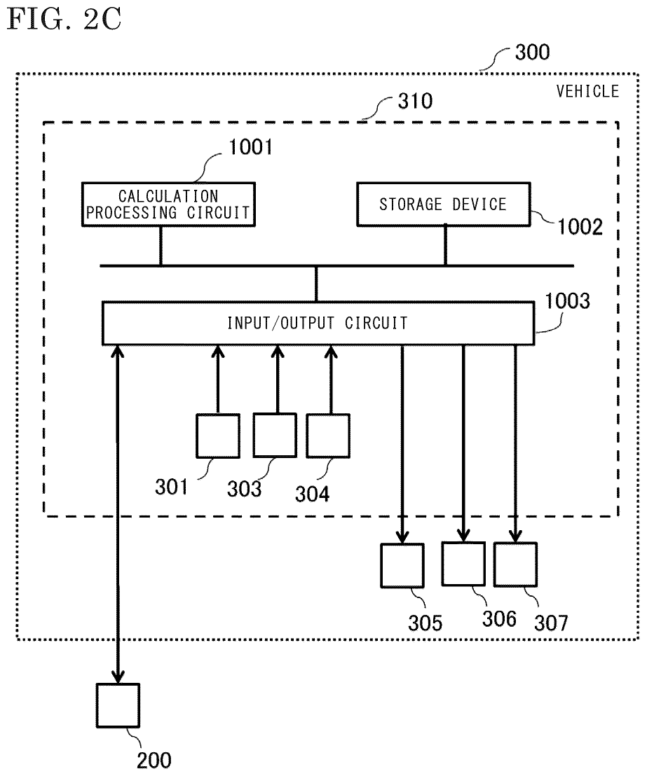

FIG. 2A shows an example of a hardware configuration of the MEC 200 according to the first embodiment, FIG. 2B shows an example of a hardware configuration of the RSU 110, and FIG. 2C shows an example of a hardware configuration of the vehicle 300 that performs automated driving according to the first embodiment. The MEC 200, the RSU 110, and the vehicle 300 each include a calculation processing circuit 1001, a storage device 1002 including a read only memory (ROM) storing a program for executing a function of each function unit and a random access memory (RAM) for storing data of an execution result of each function unit which is a calculation result of the program, and an input/output circuit 1003. The calculation processing circuit 1001 may include a processor formed by a central processing unit (CPU), and the processor may be formed by a digital signal processor (DSP) or a logic circuit. The calculation processing circuit 1001 may be formed by dedicated hardware. In a case where the calculation processing circuit 1001 is formed by dedicated hardware, the calculation processing circuit 1001 is, for example, a single circuit, a complex circuit, a programmed processor, a parallel-programmed processor, an application specific integrated circuit (ASIC), a field-programmable gate array (FPGA), or a combination thereof.

In FIG. 2A, in the MEC 200, a detection result and the like from each RSU 110 are inputted to the input/output circuit 1003, and the MEC 200 transmits/receives data to/from each vehicle 300 via the input/output circuit 1003.

In FIG. 2B, in the RSU 110, detection results from an image sensor 112, a radio-wave sensor 113, and an optical sensor 114 which are various sensors described later are inputted to the input/output circuit 1003, and a calculation result and the like are outputted to the MEC 200.

In FIG. 2C, in the vehicle 300, detection results from an own-vehicle position detection unit 301, an obstacle sensor 303, and an inertial measurement unit (IMU) sensor 304 which are detection units described later, and information from the MEC 200, are inputted via the input/output circuit 1003. A calculation result is outputted to an electric power steering (hereinafter, referred to as EPS) 305, an actuator 306, and a brake 307 described later, so that automated driving is executed.

### <Configuration of RSU 110>

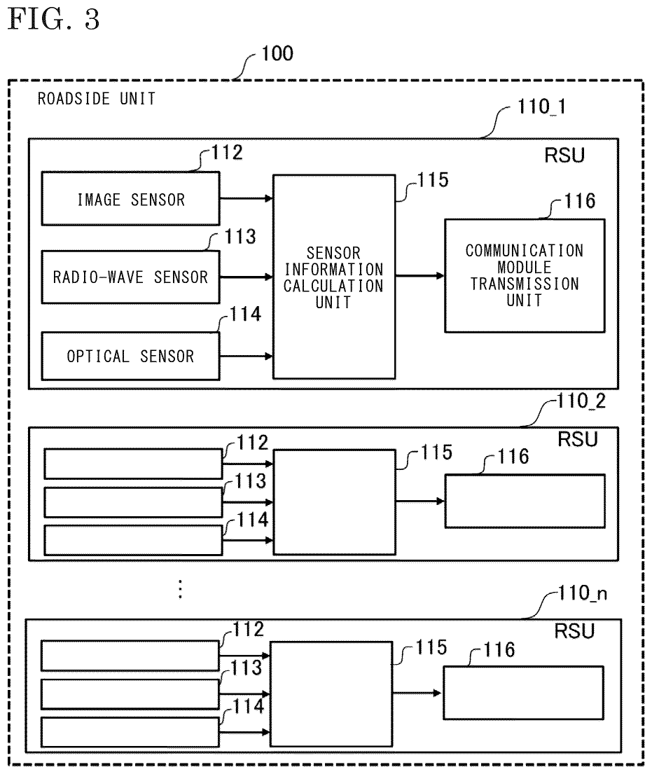

FIG. 3 shows a configuration of the roadside unit group 100 including a plurality of the RSUs 110_1, 110_2, . . . , 110_n, and is a function block diagram showing a configuration of each RSU 110. Each RSU 110 includes the image sensor 112, the radio-wave sensor 113, and the optical sensor 114 for detecting an obstacle. Each sensor includes a CPU and software for executing detection operation, and also includes a memory for storing sensor data. Each RSU 110 detects obstacle information and a traveling road surface in an area of a certain field of view.

The image sensor 112, for example, as with a front monitoring camera, captures an obstacle, and calculates a distance to the obstacle, from the image data captured in a certain field of view. Further, the image sensor 112 acquires information about a traveling road environment where the vehicle 300 travels. As an example of the traveling road environment, white line information about a traveling road on which the vehicle 300 travels is acquired.

The radio-wave sensor 113, for example, as with an MMWR, detects position information about an obstacle in a certain field of view, and also calculates the velocity of the obstacle in the field of view directly by a Doppler effect.

The optical sensor 114, for example, as with a LiDAR, radiates an optical laser beam in a certain field of view and detects point-cloud data obtained by reflection of a laser beam from an obstacle.

In the RSU 110, sensor signals outputted from the image sensor 112, the radio-wave sensor 113, and the optical sensor 114 are inputted to a sensor information calculation unit 115, in which the sensor signal outputs are collectively processed. In the sensor information calculation unit 115, filtering processing such as removing noise information of the detection signals inputted from the sensors is performed and these pieces of sensor information are collectively processed, whereby it is possible to perform obstacle presence/absence determination and identification more reliably in the surrounding environment where ranging can be performed with the field of view of the RSU 110. For example, sensor fusion processing in which different kinds of sensor information are processed so as to enhance reliability of obstacle position accuracy is performed, or an obstacle is identified on the basis of reinforcement learning such as deep learning.

Here, the processed data having undergone filtering do not always need to be collectively processed, to be transmitted to the MEC 200. All data of the plurality of RSUs 110_1, 110_2, . . . , 110_n may be collectively processed in the MEC 200, thus forming such an environment that measurement signals that might be attenuated through a plurality of filters are also collectively processed.

Through the above processing, the sensor information calculation unit 115 acquires obstacle information including identified information about position information such as the latitude and the longitude of the obstacle, the velocity of the obstacle, the height of the obstacle, the kind of the obstacle, e.g., a vehicle, a pedestrian, or a two-wheel vehicle, and the like, on the basis of a plurality of pieces of sensor information outputted from the RSU 110. Then, the above information, and also point-cloud information and image data acquired by the RSU 110, are transmitted to the MEC 200 via a communication module transmission unit 116. The sensor information calculation unit 115 for performing the above processing is provided in every RSU 110, and obstacle information calculated in each of the RSUs 110_1, 110_2, . . . , 110_n is transmitted to the MEC 200. At this time, a measurement reliability when each sensor has detected information is also transmitted to the MEC 200. In addition, if there is an RSU 110 having an abnormal state, abnormal state information is transmitted to the MEC 200.

In the RSU 110, the detection method and the identification means for an obstacle by each sensor are not limited to the above example. In addition, the sensor information may be combined with information from another sensor for detecting traffic flow or weather, for example, as necessary.

### <Configuration of MEC 200>

In FIG. 1, function blocks configuring the MEC 200 are shown. The MEC 200 receives obstacle information and abnormal state information about each RSU 110, from the plurality of RSUs 110. The hardware configuration of the MEC 200 is as shown in FIG. 2A, and the MEC 200 includes the calculation processing circuit 1001 and the storage device 1002 for storing data and processing instructions.

The MEC 200 includes a communication module reception unit 201 and a communication module transmission unit 204, for performing high-speed communication with the RSU 110.

The communication module reception unit 201 receives obstacle information including presence/absence of an obstacle and the position and the detection time of the obstacle, and a measurement reliability, from each RSU 110, and stores the obstacle information and the measurement reliability. In addition, the MEC 200 receives information about whether or not there is abnormality in the sensors provided to each RSU 110, from the RSU 110.

In addition, the communication module reception unit 201 receives position information such as the latitude and the longitude of the vehicle 300, a vehicle azimuth thereof, and a measurement reliability therefor, from the vehicle 300.

The MEC 200 includes a dynamic map generation unit 202 for superimposing the received obstacle information on a digital map, and the dynamic map generation unit 202 represents the obstacle information outputted from the communication module reception unit 201, on the map. In the present embodiment, vehicle position information about each vehicle 300A, 300B and the obstacle information acquired from the RSUs 110 are superimposed on the dynamic map, and the dynamic map is outputted to the communication module transmission unit 204.

Further, the MEC 200 defines an automated driving vehicle in an ignition-off (hereinafter, referred to as IG-OFF) state as a stopped vehicle, and includes a vehicle azimuth determination unit 203 which detects a stopped vehicle and estimates the azimuth of the stopped vehicle. The vehicle azimuth determination unit 203 receives point-cloud information and image data detected by the roadside unit group 100, and obstacle information and measurement reliabilities acquired in the corresponding detection areas, via the communication module reception unit 201, and estimates the azimuth of the stopped vehicle by a plurality of means on the basis of the above received information. In the MEC 200, a list (described later) of reliabilities and vehicle azimuths estimated by the above means is stored, and the vehicle azimuth determination unit 203 transmits the azimuth having a high reliability in the reliability list to the communication module transmission unit 204.

### <Configuration of Vehicle 300>

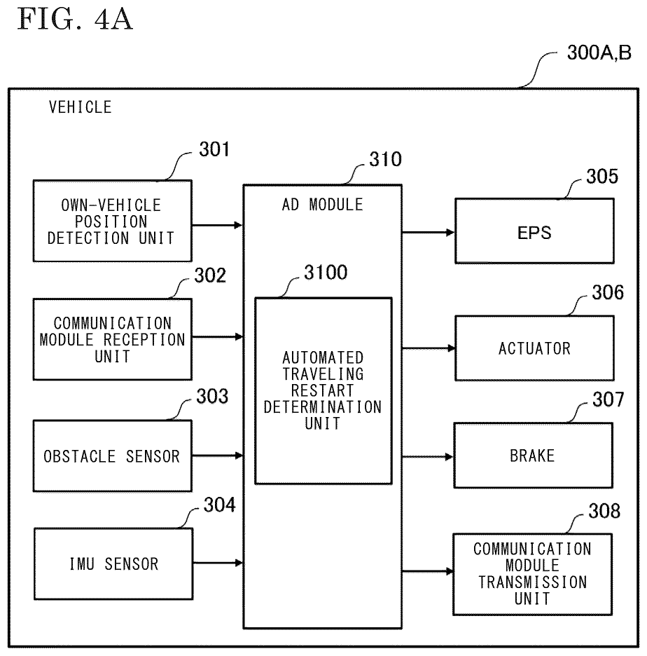

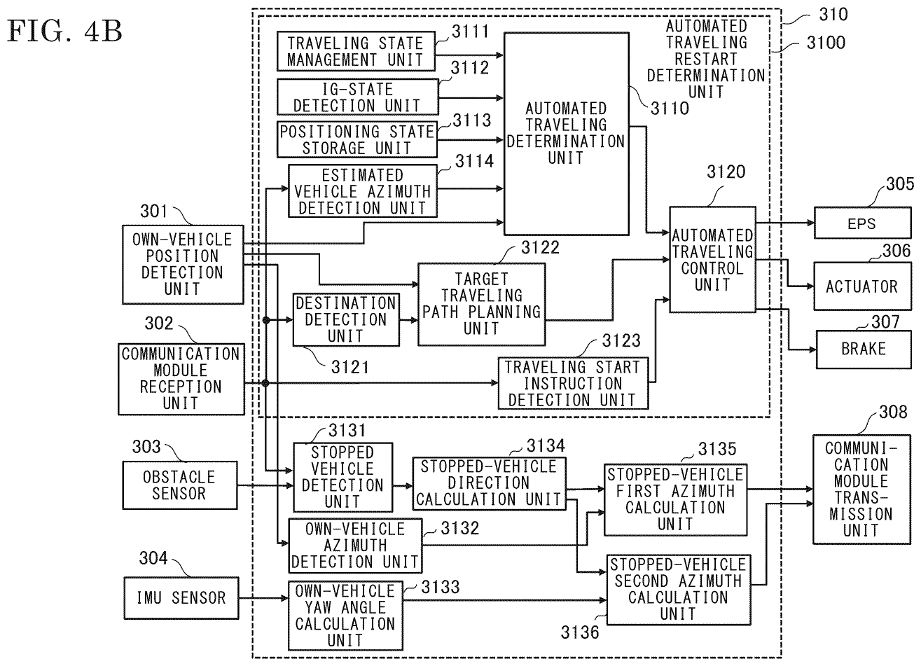

FIG. 4A is a function block diagram showing a configuration of the vehicle 300 which performs automated driving, and FIG. 4B is a function block diagram showing a configuration of an automated traveling restart determination unit of an AD module provided in the vehicle 300.

In FIG. 4A, the vehicle 300 includes: an own-vehicle position detection unit 301 which detects the position of the vehicle 300; a communication module reception unit 302 which receives a signal from the MEC 200; an obstacle sensor 303 which is provided to the vehicle and detects the distance to an obstacle; an IMU sensor 304 which detects the yaw rate of the vehicle 300; an AD module 310 having an automated traveling restart determination unit 3100 which receives the detected position information about the vehicle 300, the signal received from the MEC 200, the detected distance to the obstacle, and the detected yaw rate of the vehicle 300, together with each measurement reliability therefor, and determines whether or not to restart automated traveling of the vehicle; an EPS 305, an actuator 306, and a brake 307 which are controlled by outputs of the AD module 310; and a communication module transmission unit 308 for transmitting a calculation result of the AD module 310 to the MEC 200.

### <Configuration of AD Module 310>

With reference to FIG. 4B, the details of the AD module 310 having the automated traveling restart determination unit 3100 which determines whether or not to restart automated traveling of the vehicle will be described.

The automated traveling restart determination unit 3100 includes: a traveling state management unit 3111 which manages the traveling state of the vehicle 300; an IG-state detection unit 3112 which detects the ON/OFF state of an IG switch; a destination detection unit 3121 which detects information about a goal point to be reached by the vehicle 300; a target traveling path planning unit 3122 which receives destination information outputted from the destination detection unit 3121 and the own-vehicle position outputted from the own-vehicle position detection unit 301, and plans a target traveling path for the vehicle 300 to travel therethrough; a positioning state storage unit 3113 for storing the vehicle position of the vehicle 300, the vehicle azimuth thereof, and the measurement reliability therefor when the IG switch is off; an estimated vehicle azimuth detection unit 3114 which detects the azimuth of a stopped vehicle estimated by the MEC 200 via the communication module reception unit 302; an automated traveling determination unit 3110 which receives signals from the traveling state management unit 3111, the IG-state detection unit 3112, the positioning state storage unit 3113, the estimated vehicle azimuth detection unit 3114, and the own-vehicle position detection unit 301, and permits to restart automated traveling; a traveling start instruction detection unit 3123 for detecting a traveling start instruction transmitted by a traffic control center, a human machine interface (HMI), or the like from outside of the vehicle, via the communication module reception unit 302; and an automated traveling control unit 3120 which receives signals from the automated traveling determination unit 3110, the target traveling path planning unit 3122, and the traveling start instruction detection unit 3123.

The automated traveling control unit 3120 calculates a target operation amount, a target traveling amount, and a target braking amount, the EPS 305 controls the orientation angle of the vehicle so as to follow the target operation amount, the actuator 306 controls the vehicle velocity so as to follow the target traveling amount, and the brake 307 controls the brake amount so as to follow the target braking amount.

The target operation amount includes a target steering angle, a target steering angle degree, target torque, and the like, for example, and is calculated by the automated traveling control unit 3120. The EPS 305 controls the orientation angle of the vehicle through feedback control or feedforward control, or a combination thereof, so as to follow the above target operation amount. A controller for controlling the EPS 305 may be a component included in the automated traveling control unit 3120 or a component included in the EPS 305.

An example of the EPS 305 including the controller is an electric power steering with a steering angle sensor. The vehicle may be provided with an electric power steering controller for controlling rotation of the electric power steering with the steering angle sensor, thus implementing a configuration for performing control so as to follow a target steering angle, a target angular velocity, or a differential value thereof.

The target driving amount includes a target vehicle velocity, a target acceleration, a target jerk, target driving torque, and the like, for example, and is calculated by the automated traveling control unit 3120. The actuator 306 controls the vehicle velocity through feedback control or feedforward control, or a combination thereof, so as to follow the above target operation amount. A controller for controlling the actuator 306 may be a component included in the automated traveling control unit 3120 or a component included in the actuator 306.

As an example of the actuator 306 including the controller, a driving electric motor provided with a rotation sensor and an inverter for controlling rotation of the driving motor may be included in the vehicle, thus implementing a configuration for performing control so as to follow a target front/rear distance, a target vehicle velocity, or a differential value thereof.

The target braking amount includes a brake pressure, for example, and is calculated by the automated traveling control unit 3120. The brake 307 controls a brake amount through feedback control or feedforward control, or a combination thereof, so as to follow the target braking amount. A controller for controlling the brake 307 may be a component included in the automated traveling control unit 3120 or a component included in the brake 307.

As an example of the brake 307 including the controller, a hydraulic brake and a control unit for controlling the pressure of the hydraulic brake may be included in the vehicle, thus implementing a configuration for performing control so as to follow a target brake pressure.

The AD module 310 of the vehicle 300 further has a function of estimating the azimuth of a stopped vehicle present around a traveling road on which the vehicle 300 travels, on the basis of outputs from the communication module reception unit 302, the obstacle sensor 303, the IMU sensor 304, and the own-vehicle position detection unit 301.

The own-vehicle position detection unit 301 detects the position and the azimuth of the own vehicle on the basis of positioning information from a GNSS, for example, and also acquires a reliability at the time of positioning.

A stopped vehicle detection unit 3131 detects a stopped vehicle present around the traveling road, on the basis of point-cloud data and image data about the stopped vehicle received from the MEC 200 via the communication module reception unit 302 and the distance to the stopped vehicle detected by the obstacle sensor 303.

A stopped-vehicle direction calculation unit 3134 estimates and calculates the direction (orientation) of the stopped vehicle.

An own-vehicle azimuth detection unit 3132 acquires the azimuth of the own vehicle and a reliability at the time of positioning, from the own-vehicle position detection unit 301.

A stopped-vehicle first azimuth calculation unit 3135 calculates the azimuth of a stopped vehicle on the basis of the azimuth of the own vehicle and the reliability at the time of positioning, outputted from the own-vehicle azimuth detection unit 3132. The calculated azimuth of the stopped vehicle is transmitted, together with the position of the stopped vehicle and the reliability therefor, to the MEC 200 via the communication module transmission unit 308.

An own-vehicle yaw angle calculation unit 3133 integrates the yaw rate of the own vehicle outputted from the IMU sensor 304, to calculate the orientation angle (azimuth) of the vehicle.

A stopped-vehicle second azimuth calculation unit 3136 calculates position coordinates Σ (X, Y, Θ) of the vehicle 300 with arbitrary coordinates as an origin, using a cumulative value of a movement distance acquired from a movement distance sensor (not shown) provided to the vehicle. Means for calculating the position coordinates Σ (X, Y, Θ) may calculate position coordinates relative to arbitrary coordinates using a sensor of an encoder or a wheel velocity of a tire of an automobile or a wheel-equipped robot by a method called wheel odometry. Here, regarding the origin for the position coordinates E, since the vehicle position and the azimuth are estimated from when the positioning reliability has become equal to or smaller than a certain threshold, the position coordinates are added to the vehicle position information and the vehicle orientation angle which are absolute values and reliability information outputted from the own-vehicle position detection unit 301, whereby position coordinates Σa (Xa, Ya, Θa) can be calculated. Thus, the position on the dynamic map detected by the automated driving vehicle traveling near a stopped vehicle and the azimuth of the stopped vehicle are calculated and then transmitted to the MEC 200 via the communication module transmission unit 308.

### <Transition of Vehicle State>

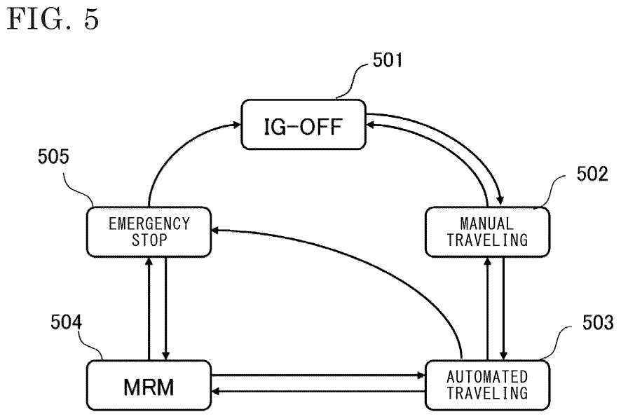

FIG. 5 shows transition of the vehicle state of the vehicle 300 which performs automated driving. In the transition of the vehicle state, vehicle states detected by the traveling state management unit 3111 are shown. In the transition of the vehicle state, there are five states: an IG-OFF state 501, a manual traveling state 502, an automated traveling state 503, a minimum risk maneuver state 504 (hereinafter, referred to as MRM state 504), and an emergency stop state 505. The traveling state management unit 3111 detects the above states and manages the traveling state of the vehicle 300.

The IG-OFF state 501 is associated with a switch provided to the vehicle, and the switch is called an ignition switch or a main switch, for example. The main switch has indications such as “OFF”, “manual”, and “automatic”, and in the first embodiment, a traveling management state corresponding to such a state of the switch is set. When a user switches the main switch from “OFF” to “manual”, the vehicle state shifts to the manual traveling state 502. On the other hand, when the user switches the main switch from “manual” to “OFF”, the vehicle state shifts from the manual traveling state 502 to the IG-OFF state 501.

When the user switches the main switch from “manual” to “automatic”, the vehicle state shifts to the automated traveling state 503. In the automated traveling state 503, if there are a target path outputted from the target traveling path planning unit 3122, a traveling start instruction outputted from the traveling start instruction detection unit 3123, and an automated traveling permission from the automated traveling determination unit 3110, traveling of the vehicle is permitted, and the vehicle 300 can execute automated traveling.

An example in which the vehicle 300 performing automated traveling cannot continue the automated traveling is a case where a state in which the positioning state reliability is reduced has continued for a certain period. The own-vehicle position detection unit 301 detects the position and the azimuth of the own vehicle and stores them together with the positioning reliability. In a case where the state in which the positioning reliability is equal to or smaller than a threshold has continued for a certain period, the vehicle state shifts from the automated traveling state 503 to the MRM state 504, and the vehicle 300 stops. Here, if reduction in the positioning reliability is temporary and the positioning reliability recovers to the threshold or greater within a certain period, the vehicle state shifts from the MRM state 504 to the automated traveling state 503 again, so that the vehicle 300 restarts automated traveling.

The emergency stop state 505 is a state in which the vehicle 300 has abnormality in vehicle hardware or a state in which an emergency stop switch in the vehicle is pressed and the vehicle cannot continue traveling. Also in a case where the positioning reliability is reduced for more than a certain period, it is determined that traveling cannot be continued, and the vehicle state shifts from the MRM state 504 to the emergency stop state 505. Further, also in a case where vehicle abnormality is detected during automated traveling in the automated traveling state 503, it is determined that automated traveling cannot be restarted immediately, so that the vehicle state shifts to the emergency stop state 505.

### <Procedure of Restart of Automated Driving>

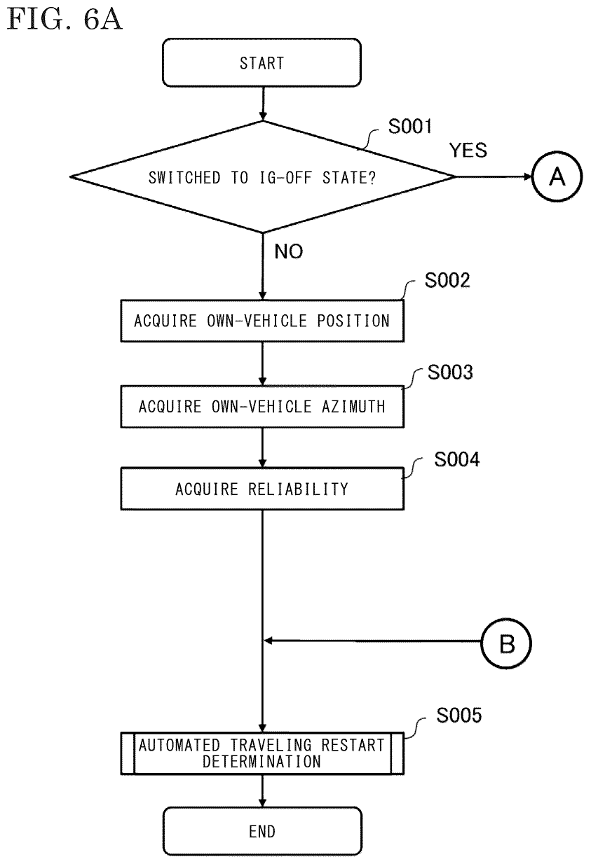

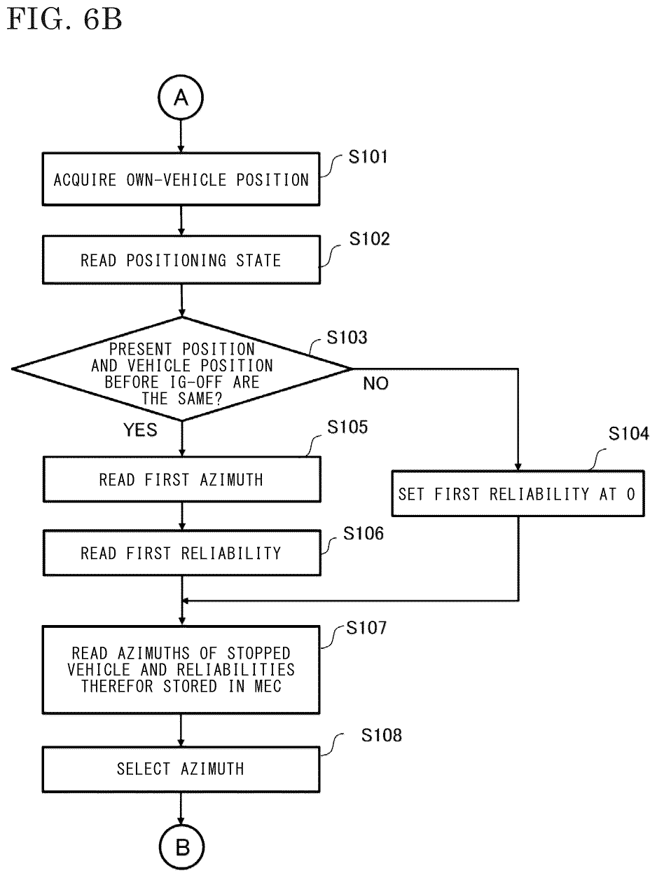

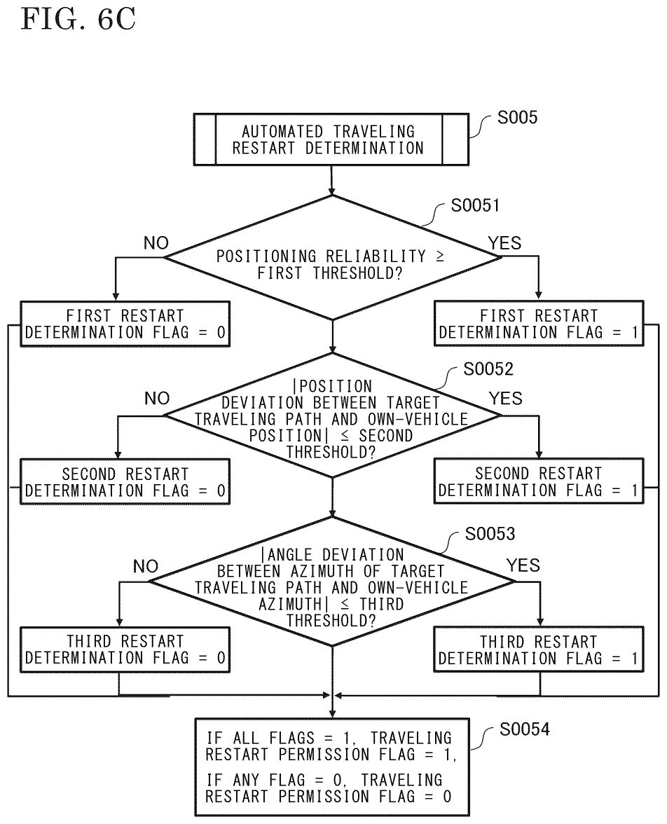

Next, operation for restarting automated driving of the vehicle 300 in the automated driving system according to the first embodiment will be described with reference to flowcharts shown in FIGS. 6A, 6B, 6C.

First, in step S001, whether or not the vehicle state is switched from the manual traveling state 502 or the automated traveling state 503 to the IG-OFF state 501 is determined. If the determination result in step S001 is NO, it is assumed that the manual traveling state 502 or the automated traveling state 503 is continuing, and the process proceeds to step S002, to acquire own-vehicle position information from the own-vehicle position detection unit 301. In step S003, own-vehicle azimuth information is acquired from the own-vehicle position detection unit 301, and in step S004, positioning reliability information is acquired from the own-vehicle position detection unit 301.

In step S005, determination for restart of automated traveling is performed on the basis of the target traveling path planned by the target traveling path planning unit 3122, and the own-vehicle position information, the azimuth information, and the positioning reliability acquired from the own-vehicle position detection unit 301.

Automated traveling restart determination is performed on the basis of whether or not the following three restart determination criteria are satisfied.

(1) A first restart determination criterion is about whether the positioning reliability information is equal to or greater than a predetermined first threshold. If the positioning reliability information is equal to or greater than the first threshold, a first restart determination flag set at 1 is outputted. If the reliability is smaller than the first threshold, the first restart determination flag set at 0 is outputted (step S0051).

(2) A second restart determination criterion is about whether the absolute value of a position deviation (transverse deviation) between the target traveling path and the own-vehicle position is equal to or smaller than a predetermined second threshold. If the position deviation is equal to or smaller than the second threshold, the second restart determination criterion is satisfied and therefore a second restart determination flag set at 1 is outputted. If the position deviation is greater than the second threshold, the second restart determination criterion is not satisfied and therefore the second restart determination flag set at 0 is outputted (step S0052).

(3) A third restart determination criterion is about whether the absolute value of an angle deviation between the azimuth of the target traveling path and the own-vehicle azimuth is equal to or smaller than a predetermined third threshold. If the angle deviation is equal to or smaller than the third threshold, the third restart determination criterion is satisfied and therefore a third restart determination flag set at 1 is outputted. If the angle deviation is greater than the third threshold, the third restart determination flag set at 0 is outputted (step S0053).

If all the first to third restart determination flags are 1, a traveling restart permission flag set at 1 is outputted. On the other hand, if at least one of the first to third restart determination flags is 0, the traveling restart permission flag set at 0 is outputted (step S0054).

By providing the restart determination criteria for automated traveling as described above, even a vehicle that has stopped because the positioning reliability information is temporarily reduced due to an unstable positioning state can automatically restart traveling after waiting for recovery of positioning reliability information, whereby a restart determination function with less intervention by manual traveling is achieved. Thus, it is possible to provide a highly reliable automated driving system that can reduce a possibility of deviating from a traveling path.

If the determination result in step S001 is YES, the process proceeds to step S101, to acquire the present own-vehicle position information from the own-vehicle position detection unit 301.

In step S102, the positioning state is read from the positioning state storage unit 3113. In the positioning state storage unit 3113, the vehicle position, the vehicle azimuth, and the positioning reliability information obtained just before IG-OFF operation, are stored. In this sequence, the information stored just before IG-OFF operation is referred to as storage-unit own-vehicle position information, storage-unit own-vehicle azimuth information, and storage-unit positioning reliability information, and the above information is acquired in step S102.

In step S103, a position deviation α between the present own-vehicle position information acquired from the own-vehicle position detection unit 301 and the storage-unit own-vehicle position information read from the positioning state storage unit 3113 is compared, to confirm that the absolute value of the position deviation α is equal to or smaller than a threshold β. Thus, it is possible to confirm whether the position of the vehicle 300 has not changed between the IG-OFF state and the IG-ON state. If the absolute value of the position deviation α is equal to or smaller than the threshold β, it is determined that the vehicle has not moved between before and after ON/OFF operation of the IG switch, and the process proceeds to step S105.

In step S105, the read storage-unit own-vehicle position information is acquired as a first azimuth, and in step S106, the read storage-unit positioning reliability information is acquired as a first reliability.

On the other hand, if the determination result in step S103 is NO, i.e., if it is determined that the vehicle has moved between before and after ON/OFF operation of the IG switch, the process proceeds to step S104. In step S104, 0 is set as the first reliability. This is processing for not selecting the storage-unit own-vehicle azimuth in azimuth selection in step S108 described later.

In step S107, azimuths of a stopped vehicle and reliabilities therefor stored in the MEC 200 are checked from the vehicle 300. In the MEC 200, at least one azimuth of a stopped vehicle calculated on the basis of point-cloud data or image data from the RSU 110 is stored as a list. In step S107, checking for azimuths of the vehicle 300 is requested from the vehicle 300 to the MEC 200. From a plurality of azimuths and reliabilities corresponding to the azimuths stored in the MEC 200, the azimuth having the highest reliability is acquired as a second azimuth. If there is no azimuth stored in the MEC 200, a reliability of 0 is acquired.

In step S108, the first azimuth and the first reliability which is a reliability therefor, read from the positioning state storage unit 3113 of the vehicle 300 in step S102 and defined in steps S105 and S106, are compared with the second azimuth and the second reliability which is a reliability therefor, acquired from the MEC 200 in step S107. The azimuth having the higher reliability between these values is selected as a vehicle azimuth, and step S005 which is the automated traveling restart determination step is executed. It is noted that, as described above, if the determination result in step S103 is NO, the first reliability is set at 0 in step S104, and therefore the second azimuth is selected in step S108.

After the azimuth is selected in step S108, determination for restarting automated traveling is performed in step S005 described above.

In a case where the process has gone through step S108, i.e., in a case where the state of the vehicle 300 is switched to the IG-OFF state in step S001, the determination is performed as follows.

Regarding the first restart determination criterion, whether or not the reliability selected in step S108 is equal to or greater than the first threshold is determined (step S0051).

Regarding the second restart determination criterion, whether or not a transverse position deviation between the target traveling path and the vehicle position acquired in step S101 is equal to or smaller than the second threshold is determined (step S0052).

Regarding the third restart determination criterion, whether or not an angle deviation between the azimuth of the target traveling path and the azimuth selected in step S108 is equal to or smaller than the third threshold is determined (step S0053).

On the basis of the first to third restart determination criteria, the determination for restarting automated traveling is finished (step S0054).

In a case where the first reliability acquired in step S106, i.e., the storage-unit positioning reliability information, is equal to or greater than the first threshold used in step S0051, step S108 may be skipped.

### <Configuration of Vehicle Azimuth Determination Unit 203 of MEC 200>

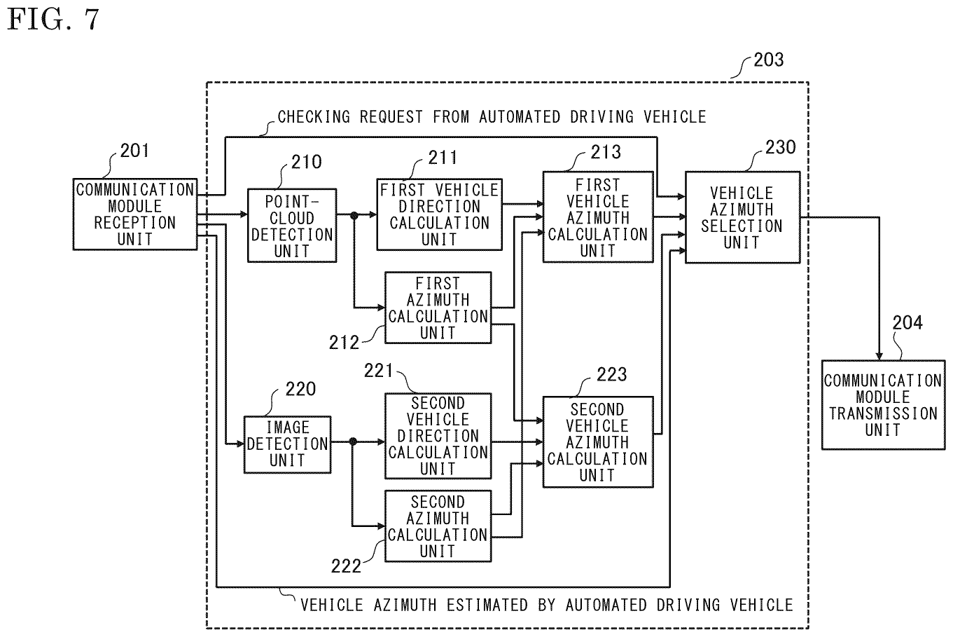

FIG. 7 shows a function block diagram of the vehicle azimuth determination unit 203 included in the MEC 200.

The vehicle azimuth determination unit 203 includes: a point-cloud detection unit 210 which detects point-cloud information from each RSU 110 via the communication module reception unit 201; a first vehicle direction calculation unit 211 which calculates the direction of a stopped vehicle on the basis of the detected point-cloud information; a first azimuth calculation unit 212 which checks a dynamic map and information about a ground object present in the field of view of the RSU 110 which transmits the point-cloud information, to calculate the azimuth of the ground object; and a first vehicle azimuth calculation unit 213 which calculates the azimuth of the stopped vehicle, using a calculation result of the first vehicle direction calculation unit 211 and a calculation result of the first azimuth calculation unit 212.

The first vehicle direction calculation unit 211 calculates the direction (i.e., the vehicle orientation angle) of the stopped vehicle from the detected point-cloud information. Normally, a vehicle can be identified from point-cloud information obtained by an optical sensor (e.g., LiDAR), and the vehicle and another space can be discriminated from each other on the basis of presence/absence of reflection points. Therefore, if point-cloud information is detected, the point-cloud information outputted from the RSU 110 corresponds to a vehicle, and the direction thereof can also be determined. Specifically, the first vehicle direction calculation unit 211 estimates a first vehicle direction for a stopped vehicle on the basis of point-cloud information outputted from the point-cloud detection unit 210. As the estimation method, there is a method in which feature points (e.g., ends or a contour of a vehicle) of a vehicle are detected from point-cloud data, and the orientation of the vehicle is estimated from arrangement and a relationship of the feature points. Alternatively, there is a method in which point-cloud data are clustered, a point cloud of a vehicle is separated, and the clusters are analyzed to estimate the shape and the orientation of the vehicle. Still alternatively, there is a method in which point-cloud data are inputted to a neural network suitable for point-cloud processing, to estimate the orientation of a vehicle.

The first azimuth calculation unit 212 identifies registered ground object information from the point-cloud data detected by the point-cloud detection unit 210, and measures a ground object direction, using at least one ground object. For example, there are static objects such as buildings and traffic lights, these static objects are registered on the dynamic map, and point-cloud information and ground objects are associated with each other. That is, the azimuth of each ground object registered on the dynamic map can be used as a ground object reference azimuth.

In the first vehicle azimuth calculation unit 213, since the ground object reference azimuth calculated by the first azimuth calculation unit 212 and the first vehicle direction estimated by the first vehicle direction calculation unit 211 are both on the dynamic map, the azimuth of the vehicle on the dynamic map is defined as a ground object reference estimated vehicle azimuth on the basis of a relative angle between the estimated first vehicle direction and the ground object reference azimuth, and a ground object reference reliability is calculated from the reliability of point-cloud information.

Here, the ground object reference estimated vehicle azimuth is calculated using the point-cloud information outputted from the RSU 110. With the optical sensor included in the RSU 110, a map having detection accuracy according to a detection distance is provided, and in general, detection accuracy is deteriorated when a far obstacle is detected. Therefore, a correction term is provided so as to reduce the ground object reference reliability in a case where a far obstacle is detected.

The vehicle azimuth determination unit 203 further includes: an image detection unit 220 which detects image information from each RSU 110 via the communication module reception unit 201; a second vehicle direction calculation unit 221 which calculates the direction of a stopped vehicle on the basis of the detected image information; a second azimuth calculation unit 222 which calculates the azimuth of a traveling road in the image information; and a second vehicle azimuth calculation unit 223 which calculates the azimuth of the stopped vehicle, using a calculation result of the second vehicle direction calculation unit 221 and a calculation result of the second azimuth calculation unit 222.

The image detection unit 220 detects image data captured by the RSU 110 and a reliability for each pixel, and outputs them to the second vehicle direction calculation unit 221 and the second azimuth calculation unit 222.

The second vehicle direction calculation unit 221 has means for estimating the direction of a stopped vehicle from image data, and estimates and outputs a second vehicle direction. As a method for estimating the orientation of a stopped vehicle, there are a method in which a stopped vehicle is detected from an image using an object detection algorithm such as You Only Look Once (YOLO) or Single Shot Multibox Detector (SSD) and the orientation thereof is estimated from the detection result, a method in which feature points (e.g., corners and edges) of a vehicle in an image are detected and the orientation of the vehicle is estimated from the feature points, and a method in which image data is inputted to a neural network to directly estimate the orientation of a vehicle, for example. For such methods, a convolutional neural network (CNN) or a pose estimation network is used.

The second azimuth calculation unit 222 for calculating an azimuth from a traveling road has white line detection means for detecting a white line present on a traveling road, and can make association with a traveling road on the dynamic map on the basis of the direction of the white line calculated by the white line detection means, to calculate a white line reference azimuth.

As a method for white line detection, there are a method in which an image is converted into a grayscale image, and with a threshold set, pixels of a white line are converted into white (255) and other backgrounds are converted into black (0), to discriminate a bright white line area in a binary processing manner, a method in which, using an edge detection algorithm, an edge in an image is detected to extract the position of a white line, and a method in which a line is detected from an edge image by Hough transform, for example.

In the second vehicle azimuth calculation unit 223, since the estimated second vehicle direction outputted from the second vehicle direction calculation unit 221 and the white line reference azimuth outputted from the second azimuth calculation unit 222 are both on the dynamic map, a relative angle therebetween can be calculated on the dynamic map. That is, a white line reference estimated vehicle azimuth can be calculated by adding the estimated second vehicle direction to the white line reference azimuth. At this time, a corresponding reliability is also calculated together.

Here, the white line reference estimated vehicle azimuth calculated by the second azimuth calculation unit 222 is calculated using image information outputted from the RSU 110. With the image sensor included in the RSU 110, a map having detection accuracy corresponding to the content rate of noise such as sunshine as disturbance information is provided, and in general, detection accuracy is deteriorated when a far obstacle is detected. Therefore, a correction term is provided so as to reduce the ground object reference reliability in a case where a far obstacle is detected.

In the first azimuth calculation unit 212 for calculating the ground object reference azimuth, if there is no specific ground object to be registered on the dynamic map and thus the ground object reference azimuth cannot be calculated, the white line reference azimuth calculated by the white line detection means may be inputted to the first vehicle azimuth calculation unit 213, to calculate the azimuth of the stopped vehicle. Similarly, on a traveling road with no white lines, the second vehicle azimuth calculation unit 223 may calculate the azimuth of the stopped vehicle, using the ground object reference azimuth from the first azimuth calculation unit 212.

Further, the vehicle azimuth determination unit 203 includes a vehicle azimuth selection unit 230. The vehicle azimuth selection unit 230 receives the azimuth of the stopped vehicle based on the estimated first vehicle direction, and the reliability therefor, outputted from the first vehicle azimuth calculation unit 213, the azimuth of the stopped vehicle based on the estimated second vehicle direction, and the reliability therefor, outputted from the second vehicle azimuth calculation unit 223, and the azimuth of the stopped vehicle estimated by each automated driving vehicle and the reliability therefor. That is, a list of a plurality of vehicle azimuths and reliabilities associated therewith with respect to stopped vehicles is provided.

In the vehicle azimuth selection unit 230, there is a reliability list associated with a plurality of vehicle azimuths with respect to stopped vehicles, stored in the MEC 200, and the vehicle azimuth having the highest reliability in the list is selected and outputted, in response to a checking request (S107) from an automated driving vehicle via the communication module reception unit 201. That is, on the basis of the reliability list generated by receiving the estimated vehicle azimuths from the first vehicle azimuth calculation unit 213, the second vehicle azimuth calculation unit 223, and another vehicle, the azimuth having the greatest reliability is selected and outputted to the communication module transmission unit 204.

Here, the “reliabilities” will be described using examples.

(1) Positioning Reliability of Positioning Information from GNSS

A positioning reliability is calculated using a Kalman filter for positioning information.

A latitude and a longitude detected from the GNSS are set as state variables and position error is calculated in real time. First, an area A of a two-dimensional error ellipse is calculated using an eigenvalue of a covariance matrix P. The covariance matrix P is a matrix representing uncertainty of error and is represented by the following Expression (1) in a two-dimensional case.

$$\begin{matrix}[ Mathematical 1 ] & \\ P = [ \begin{matrix}{σ}_{x}^{2} & {ρ}_{xy} {σ}_{x} {σ}_{y} \\ {ρ}_{xy} {σ}_{x} {σ}_{y} & {σ}_{y}^{2}\end{matrix} ] & ( 1 )\end{matrix}$$

Here, σₓ and σ_{y} are standard deviations in the X-axis and Y-axis directions, and Oxy is a correlation coefficient between X and Y.

The area A of the error ellipse is calculated in association with eigenvalues (λ1, λ2) of the covariance matrix P as shown by the following Expression (2).

$$A = π * sprt ( λ 1 * λ 2 ) \qquad ( 2 )$$

The area A of the error ellipse indicates spread of errors, and the larger the area A is, the lower the reliability is, and the smaller the area A is, the higher the reliability is. That is, when the error ellipse is small, a measurement result is reliable and close to a true value, but when the error ellipse is large, the reliability of a measurement result is low.

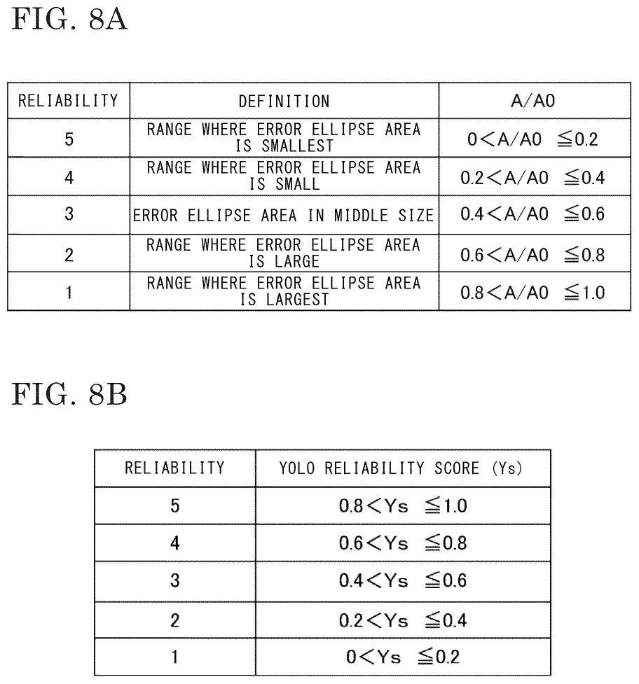

FIG. 8A shows an example in which reliabilities are set using the area A of the error ellipse. In FIG. 8A, A0 is an ellipse area measured in advance and reliabilities can be calculated on the basis of values normalized for the ellipse area.

### (2) Reliability of Azimuth

The reliability of an azimuth can be calculated in the same manner as the reliability of positioning information about a latitude and a longitude. That is, regarding the azimuth and the angular velocity which is a change rate of the azimuth, the angular velocity is set as a state variable and an area Ad of an error ellipse is calculated. Using an area Ad0 of an error ellipse of an angular velocity measured in advance, Ad/Ad0 is calculated and then associated with a reliability similarly to FIG. 8A.

### (3) Reliability of Object Detection Based on Image (Camera)

Normally, the reliability of object detection based on an image can be automatically acquired at the time of using an object recognition library or framework. For example, in an algorithm of YOLO, each detection is associated with a reliability score indicating assuredness with which a corresponding object is actually present. This is normally represented in a range of 0 to 1, and a higher score indicates that the model is confident in the detection. FIG. 8B shows an example in which reliabilities of object detection based on an image are set using reliability scores of YOLO.

### (4) Reliability of Measurement Data by LiDAR

The reliability of position information (X, Y, Z) detected by LiDAR can also be calculated using a Kalman filter, for example. In this case, to evaluate the reliability in a three-dimensional space, a three-dimensional error ellipse is calculated.

The three-dimensional error ellipse indicates uncertainty of position information in consideration of errors along X, Y, Z coordinate axes. Thus, the position reliability can be represented three-dimensionally. For example, with position coordinates (Xt, Yt, Zt) set as state variables, a 3×3 covariance matrix is defined, to calculate a volume S of an error ellipse. S0 is the volume of an error ellipse measured in advance, and a reliability is associated on the basis of a value S/S0 normalized for the ellipse volume. Association with the reliability is made in the same manner as shown in FIG. 8A.

A measurement reliability at the time of acquiring information from another sensor (not shown) is also set in the same manner as described above.

It is necessary that reliabilities can be compared among different acquisition methods. This can be achieved by performing normalization with the acquisition methods weighted, for example.

In a case where the position and the azimuth of a vehicle are calculated using a plurality of pieces of information, the reliability therefor may be calculated by weighting or averaging reliabilities of the pieces of information used in the calculation. Alternatively, a value having the smaller reliability may be used.

Here, reliabilities such as the positioning reliability of positioning information from the GNSS, the reliability of object detection based on an image (camera), and the reliability of measurement data by LiDAR, are referred to as “measurement reliabilities” or simply as “reliabilities”, in the description.

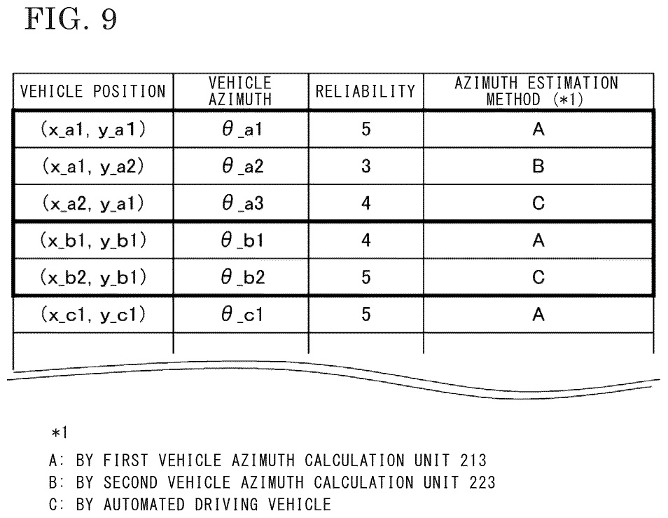

FIG. 9 shows an example of a list of azimuths of stopped vehicles and reliabilities therefor, included in the MEC 200. For example, in a case where there is a checking request from an automated driving vehicle present at a vehicle position (x_a, y_a), information about vehicle positions in the first to third rows of the list in FIG. 9 is information about the stopped vehicle (x_a, y_a), and a vehicle azimuth θ_a1 assigned with a reliability 5 which is the highest of the corresponding reliabilities is outputted to the communication module transmission unit 204. In a case of a vehicle position (x_b, y_b), a reliability is selected from information in the next two rows.

<Specific Example in which Stopped Vehicle Restarts Automated Driving Traveling>

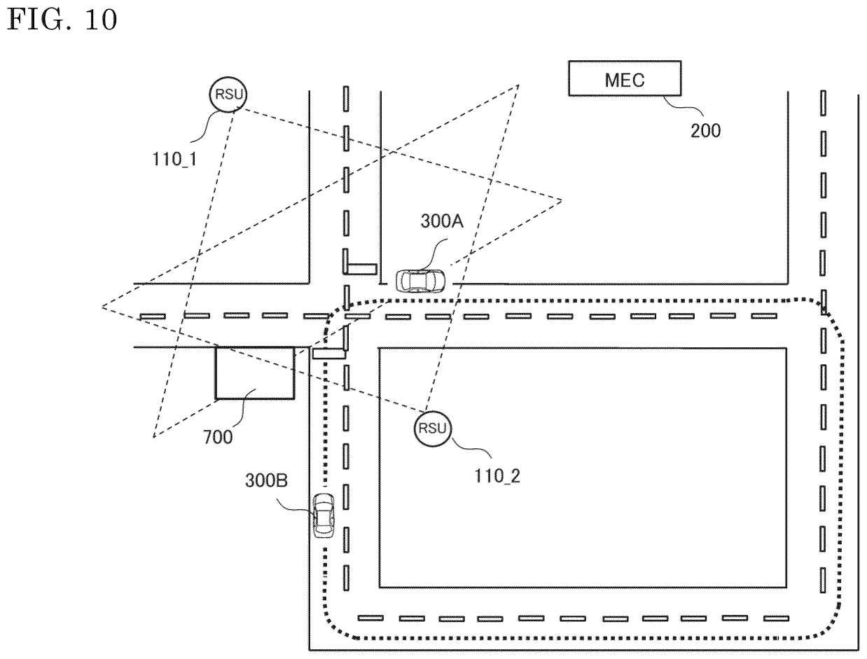

FIG. 10 illustrates restart of automated driving traveling. A vehicle 300A and a vehicle 300B in the drawing have similar AD modules, and travel along a target traveling path indicated by a dotted line in the drawing. At this time, the vehicle 300A is stopped at a position in the drawing and is in an IG-OFF state. The vehicle 300A is present in sensor fields of view of the RSU 110_1 and the RSU 110_2 (triangular areas indicated by broken lines). The RSU 110_1 and the RSU 110_2 each detect a ground object 700 and white lines, and calculate the azimuths and the reliabilities therefor. The vehicle 300B is traveling along the target traveling path, and the vehicle 300B detects the stopped vehicle 300A as an obstacle when turning right at an intersection.

The vehicle 300B also includes the AD module shown in FIG. 4B. The traveling vehicle 300B detects the vehicle 300A in an IG-OFF state by the obstacle sensor 303 when turning right at the intersection. The stopped-vehicle direction calculation unit 3134 of the vehicle 300B estimates a vehicle direction on the basis of obstacle information outputted from the obstacle sensor 303. For example, the vehicle direction of the vehicle 300A can be estimated on the basis of reflection points from the obstacle by the optical sensor provided to the vehicle 300B. The vehicle direction of the vehicle 300A may be calculated using the image sensor provided to the vehicle 300B.

The own-vehicle azimuth detection unit 3132 of the vehicle 300B acquires the azimuth of the vehicle 300B from the own-vehicle position detection unit 301 of the vehicle 300B. The stopped-vehicle first azimuth calculation unit 3135 calculates the azimuth of the stopped vehicle 300A and the reliability therefor on the basis of the vehicle direction outputted from the stopped-vehicle direction calculation unit 3134 and the own-vehicle azimuth of the vehicle 300B, and outputs them to the communication module transmission unit 308.

The own-vehicle yaw angle calculation unit 3133 of the vehicle 300B calculates the yaw angle of the vehicle 300B by accumulating yaw rate information outputted from the IMU sensor 304 of the vehicle 300B, and a traveling distance by cumulative calculation based on a movement distance sensor (not shown), and the position coordinates ¿ from an arbitrary point are calculated. Then, the vehicle position and the vehicle azimuth of the vehicle 300A on the dynamic map are calculated and outputted to the communication module transmission unit 308.

These operations are the same as those described in FIG. 4B.

The MEC 200 calculates the vehicle position, the azimuth, and the reliability about the vehicle 300B which is a stopped vehicle present in the detection ranges RSU 110_1 and RSU 110_2, on the basis of point-cloud information and image information received from the RSU 110_1 and the RSU 110_2. Further, the vehicle position, the azimuth, and the reliability about the stopped vehicle 300A detected as an obstacle by the vehicle 300B are transmitted from the vehicle 300B, and thus a list of azimuths and reliabilities corresponding to vehicle positions of stopped vehicles as shown in FIG. 8 is generated.

In the stopped vehicle 300A, in a case of restarting automated traveling from an IG-OFF state, operations in steps S101 to S107 described above are sequentially performed, and in step S107, checking of the azimuth and the reliability for the own vehicle 300A which is a stopped vehicle is performed for the MEC 200. In the MEC 200, the vehicle azimuth selection unit 230 selects the azimuth having the highest reliability from the azimuths and the reliabilities corresponding to the vehicle position of the vehicle 300A which is a stopped vehicle, and the selected azimuth is transmitted to the vehicle 300A via the communication module transmission unit 204.

In a case where the vehicle azimuth cannot be measured by the above method, i.e., in a case where automated traveling cannot be restarted on the basis of the first to third restart determination criteria in step S005, it may be effective to cause the vehicle to travel by a slight distance so as to update positioning information from the GNSS. As a result of traveling by a short distance, new position information is acquired, whereby a more accurate azimuth can be estimated. As long as it is confirmed that there is no nearby obstacle by obstacle sensors provided to the RSUs and the vehicle, automated traveling by a short distance is permitted, to measure the vehicle azimuth.

As described above, according to the present embodiment, an automated driving system includes a vehicle having a target traveling path for performing automated traveling and acquires a position and an azimuth of the vehicle and a measurement reliability therefor. The vehicle includes an automated traveling restart determination unit for switching from a stopped state to automated traveling. In a case where the measurement reliability is equal to or greater than a predetermined first threshold, restart of automated traveling of the vehicle is permitted when an absolute value of a first position deviation between the target traveling path and the position of the vehicle is equal to or smaller than a predetermined second threshold and an absolute value of an angle deviation between an azimuth of the target traveling path and the azimuth of the vehicle is equal to or smaller than a predetermined third threshold. With this configuration, when the automated driving vehicle shifts from a stopped state to a traveling state, whether or not automated traveling can be restarted is determined using the position, the azimuth, and the measurement reliability about the vehicle acquired in the automated driving system. Thus, it is possible to smoothly restart automated traveling on the basis of an azimuth assured by highly reliable information, while being less intervened by a user.

The automated driving vehicle includes an own-vehicle position detection unit which detects a position and an azimuth of the own vehicle and acquires a measurement reliability therefor, and a positioning state storage unit which stores the position and the azimuth of the own vehicle and the reliability therefor acquired by the own-vehicle position detection unit at a time of finish of automated traveling. The automated traveling restart determination unit of the vehicle calculates a second position deviation between the position of the own vehicle detected by the own-vehicle position detection unit before start of traveling and the position of the own vehicle at a last time of finish of automated traveling stored in the positioning state storage unit. In a case where the second position deviation is equal to or smaller than a predetermined fourth threshold, the automated traveling restart determination unit of the vehicle performs determination for restart of automated traveling of the vehicle, using the azimuth of the own vehicle and the measurement reliability therefor at the last time of finish of automated traveling stored in the positioning state storage unit. With this configuration, even in a case where positioning information is uncertain in the own-vehicle position detection unit just after shifting from a stopped state to a traveling state, for example, whether or not automated traveling can be restarted can be determined using information including the azimuth, stored in the positioning state storage unit. Thus, it becomes possible to smoothly restart automated traveling using highly reliable information about the position and the azimuth of a vehicle, while being less intervened by a user.

The automated driving system according to the present embodiment further includes: at least one RSU which detects an obstacle and a traveling road surface in a field of view; and an MEC which outputs obstacle information including a position and an azimuth of the obstacle and a reliability therefor acquired from the RSU, to the vehicle. The automated traveling restart determination unit of the vehicle compares the measurement reliability at a time of acquisition of the position of the own vehicle detected by the own-vehicle position detection unit before start of traveling and the reliability for the position of the own vehicle included in the obstacle information acquired from the MEC, and performs determination for restart of automated traveling of the vehicle, using the position and the azimuth of the own vehicle associated with a greater one of the compared reliabilities.

Further, the automated driving system according to the present embodiment includes a plurality of the vehicles for performing automated traveling. The vehicles each include an obstacle sensor which detects an obstacle around the own vehicle, and a stopped-vehicle direction calculation unit which detects, as a stopped vehicle, another vehicle that has stopped, from the obstacle detected by the obstacle sensor, and estimates a direction of the stopped vehicle. Using the azimuth of the own vehicle and the direction of the stopped vehicle calculated by the stopped-vehicle direction calculation unit, the azimuth of the stopped vehicle is calculated and transmitted to the MEC.

As described above, at the time of shifting from a stopped state to a traveling state, the automated driving vehicle can also use obstacle information acquired from the RSU and information about a stopped vehicle acquired from another vehicle, whereby it becomes possible to acquire an azimuth with a higher measurement reliability, and redundancy is improved. Thus, it becomes possible to smoothly restart automated traveling on the basis of the azimuth having the highest reliability among a plurality of sets of vehicle positions, azimuths, and reliabilities, while being less intervened by a user.

### Second Embodiment

Hereinafter, an automated driving system according to the second embodiment of the present disclosure will be described with reference to the drawings.

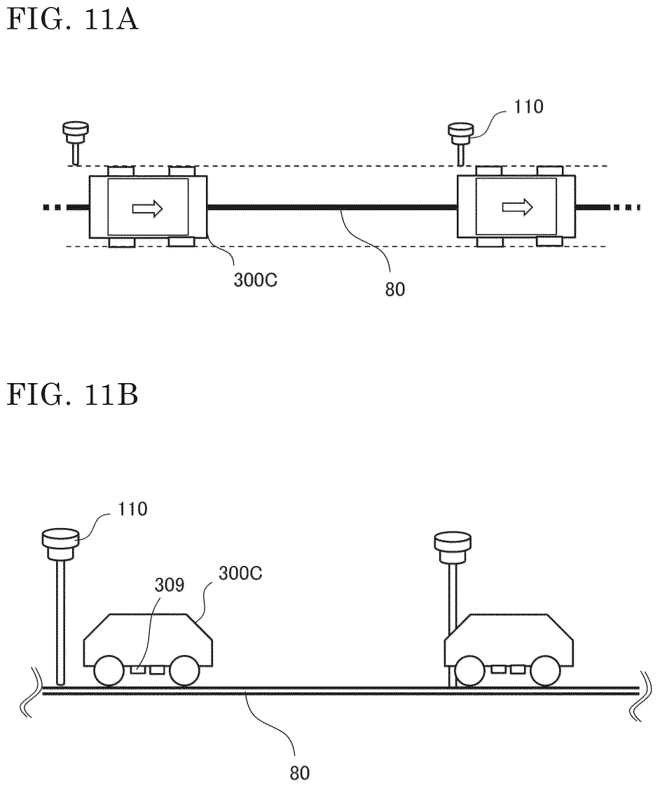

FIG. 11A and FIG. 11B illustrate a traveling path for a vehicle in the automated driving system according to the second embodiment. FIG. 11A is a view as seen from above and FIG. 11B is a view as seen from a lateral side. In the second embodiment, an example in which a vehicle 300C performs following traveling above an electromagnetic guide wire 80 installed at a road surface, instead of using virtual values as a target traveling path, will be described.

In FIG. 11A and FIG. 11B, the vehicle 300C has a guide sensor 309 which detects a varying magnetic field from the electromagnetic guide wire 80. It is desirable that a plurality of guide sensors 309 are provided at the bottom of the vehicle 300C. The vehicle 300C has a dynamic map including the electromagnetic guide wire and thus can estimate the position and the azimuth of a vehicle. In this case, for example, a reliability can be calculated using the level of noise of the guide sensor 309. In a case where the RSUs 110 are provided along the electromagnetic guide wire 80, information from the RSUs can be used in the same manner as in the first embodiment.

As described above, according to the second embodiment, the same effects as in the first embodiment are provided. In addition, since the vehicle travels above the electromagnetic guide wire, the position and the azimuth of the vehicle can be estimated without using the own-vehicle position detection unit. Alternatively, a reliability for the position and the azimuth of the vehicle is improved when the own-vehicle position detection unit is used in combination.

In the first and second embodiments, a case of using vehicles has been described as an example. However, an application target of the automated driving system is not limited to an automobile, and the automated driving system may be applied to other various types of mobile objects. For example, the automated driving system is applicable to a configuration including a mobile object for performing automated traveling on a target path, such as an in-building mobile robot for inspecting the inside of a building, a line inspection robot, and a personal mobility. In this case, as obstacle information or the like to be acquired by the RU 100, information from an obstacle information detector provided in a building, a line, or a range in which a personal mobility moves, may be used, for example.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

Hereinafter, modes of the present disclosure are summarized as additional notes.

### (Additional Note 1)

An automated driving system comprising a vehicle having a target traveling path for performing automated traveling, the automated driving system being configured to acquire a position and an azimuth of the vehicle and a measurement reliability therefor, wherein
the vehicle includes an automated traveling restart determination unit for switching from a stopped state to automated traveling, and
in a case where the measurement reliability is equal to or greater than a predetermined first threshold,
restart of automated traveling of the vehicle is permitted when an absolute value of a first position deviation between the target traveling path and the position of the vehicle is equal to or smaller than a predetermined second threshold and an absolute value of an angle deviation between an azimuth of the target traveling path and the azimuth of the vehicle is equal to or smaller than a predetermined third threshold.

### (Additional Note 2)

The automated driving system according to additional note 1, wherein
the vehicle includes
   an own-vehicle position detection unit which detects a position and an azimuth of the own vehicle and acquires a measurement reliability therefor, and
   a positioning state storage unit which stores the position and the azimuth of the own vehicle and the measurement reliability therefor acquired by the own-vehicle position detection unit at a time of finish of automated traveling, and
the automated traveling restart determination unit of the vehicle
   calculates a second position deviation between the position of the own vehicle detected by the own-vehicle position detection unit before start of traveling and the position of the own vehicle at a last time of finish of automated traveling stored in the positioning state storage unit, and
   in a case where the second position deviation is equal to or smaller than a predetermined fourth threshold, performs determination for restart of automated traveling of the vehicle, using the azimuth of the own vehicle and the measurement reliability therefor at the last time of finish of automated traveling stored in the positioning state storage unit.

### (Additional Note 3)

The automated driving system according to additional note 2, further comprising:
at least one roadside unit which detects an obstacle and a traveling road surface in a field of view; and
an edge computer which outputs obstacle information including a position and an azimuth of the obstacle and a measurement reliability therefor acquired from the roadside unit, to the vehicle, wherein
the automated traveling restart determination unit of the vehicle compares magnitudes of the measurement reliability at a time of acquisition of the position of the own vehicle detected by the own-vehicle position detection unit before start of traveling and the measurement reliability for the position of the own vehicle included in the obstacle information acquired from the edge computer, and performs determination for restart of automated traveling of the vehicle, using the position and the azimuth of the own vehicle associated with a greater one of the compared measurement reliabilities.

### (Additional Note 4)

The automated driving system according to additional note 3, wherein
the roadside unit includes an optical sensor, and reflection points from the obstacle in the field of view are included as point-cloud data in the obstacle information, and
the edge computer includes
   a first vehicle direction calculation unit which calculates a direction of a stopped vehicle on the basis of the obstacle information,
   a first azimuth calculation unit which calculates an azimuth of a ground object fixed in the field of view on the basis of reflection points from the ground object in the obstacle information, and
   a first vehicle azimuth calculation unit which calculates an azimuth of the stopped vehicle and a measurement reliability therefor, using the direction of the stopped vehicle calculated by the first vehicle direction calculation unit and the azimuth of the ground object calculated by the first azimuth calculation unit.

### (Additional Note 5)

The automated driving system according to additional note 4, wherein
in the obstacle information acquired from the roadside unit, the measurement reliability is decreased with increase in a detection distance to the obstacle.
   (Additional note 6)

The automated driving system according to any one of additional notes 3 to 5, wherein
the roadside unit includes an image sensor, and white line information of a traveling road surface is included in the obstacle information, and
the edge computer includes
   a second vehicle direction calculation unit which calculates a direction of a stopped vehicle on the basis of the obstacle information from the image sensor,
   a second azimuth calculation unit which calculates a white line reference azimuth which is a direction of a road, from the white line information included in the obstacle information, and
   a second vehicle azimuth calculation unit which calculates an azimuth of the stopped vehicle and a measurement reliability therefor, using the direction of the stopped vehicle calculated by the second vehicle direction calculation unit and the white line reference azimuth calculated by the second azimuth calculation unit.

### (Additional Note 7)

The automated driving system according to additional note 6, wherein
in the obstacle information acquired from the roadside unit, the measurement reliability is decreased with increase in a detection distance to the obstacle.

### (Additional Note 8)

The automated driving system according to additional note 7, wherein
the measurement reliability is decreased in a case where a content rate of noise in an image acquired from the image sensor of the roadside unit is equal to or greater than a predetermined noise threshold.

### (Additional Note 9)

The automated driving system according to any one of additional notes 3 to 8, comprising a plurality of the vehicles for performing automated traveling, wherein
each vehicle includes
   an obstacle sensor which detects an obstacle around the own vehicle,
   a stopped-vehicle direction calculation unit which detects, as a stopped vehicle, another vehicle that has stopped, from the obstacle detected by the obstacle sensor, and estimates a direction of the stopped vehicle, and
   a stopped-vehicle first azimuth calculation unit which calculates an azimuth of the stopped vehicle, using the azimuth of the own vehicle and the reliability therefor acquired by the own-vehicle position detection unit and the estimated direction of the stopped vehicle, and
each vehicle transmits the azimuth of the stopped vehicle calculated by the stopped-vehicle first azimuth calculation unit, together with a position thereof and a measurement reliability therefor, to the edge computer.

### (Additional Note 10)

The automated driving system according to any one of additional notes 3 to 9, comprising a plurality of the vehicles for performing automated traveling, wherein
each vehicle includes
   an obstacle sensor which detects an obstacle around the own vehicle,
   a sensor which detects a yaw rate of the own vehicle,
   a stopped-vehicle direction calculation unit which detects, as a stopped vehicle, another vehicle that has stopped, from the obstacle detected by the obstacle sensor, and estimates a direction of the stopped vehicle,
   a yaw angle calculation unit which calculates an azimuth of the own vehicle from a yaw angle obtained by integrating the detected yaw rate, and
   a stopped-vehicle second azimuth calculation unit which calculates an azimuth of the stopped vehicle, using the azimuth of the own vehicle calculated by the yaw angle calculation unit and the estimated direction of the stopped vehicle, and
each vehicle transmits the azimuth of the stopped vehicle calculated by the stopped-vehicle second azimuth calculation unit, together with a position thereof and a measurement reliability therefor, to the edge computer.

### (Additional Note 11)

The automated driving system according to additional note 10, wherein
in a case where the measurement reliability for the position and the azimuth of the own vehicle detected by the own-vehicle position detection unit has become equal to or smaller than a predetermined threshold, the vehicle transmits, to the edge computer, the measurement reliability at that time and a position of the vehicle calculated by accumulating a movement distance acquired by a movement distance sensor provided to the vehicle.

### (Additional Note 12)

The automated driving system according to any one of additional notes 9 to 11, wherein
the automated traveling restart determination unit of the vehicle compares magnitudes of the measurement reliability at the time of acquisition of the position of the own vehicle detected by the own-vehicle position detection unit before start of traveling, the measurement reliability for the position of the own vehicle included in the obstacle information acquired from the edge computer, and the measurement reliability for the stopped vehicle acquired from the edge computer, and performs determination for restart of automated traveling of the vehicle, using the position and the azimuth of the own vehicle associated with a greatest one of the compared measurement reliabilities.

### (Additional Note 13)

The automated driving system according to any one of additional notes 1 to 3, wherein
the vehicle is a vehicle that performs following traveling above an electromagnetic guide wire installed at a road surface, and
the vehicle includes a guide sensor which detects a varying magnetic field from the electromagnetic guide wire, and map information including the electromagnetic guide wire.

### DESCRIPTION OF THE REFERENCE CHARACTERS

80 electromagnetic guide wire
100 roadside unit group
110, 110_1, 110_2, 110_n roadside unit (RSU)
112 image sensor
113 radio-wave sensor
114 optical sensor
115 sensor information calculation unit
116 communication module transmission unit
200 multi-access edge computer (MEC)
201 communication module reception unit
202 dynamic map generation unit
203 vehicle azimuth determination unit
204 communication module transmission unit
210 point-cloud detection unit
211 first vehicle direction calculation unit
212 first azimuth calculation unit
213 first vehicle azimuth calculation unit
220 image detection unit
221 second vehicle direction calculation unit
222 second azimuth calculation unit
223 second vehicle azimuth calculation unit
230 vehicle azimuth selection unit
300, 300A, 300B, 300C vehicle
301 own-vehicle position detection unit
302 communication module reception unit
303 obstacle sensor
304 IMU sensor
305 electric power steering (EPS)
306 actuator
307 brake
308 communication module transmission unit
309 guide sensor
310 automated driving module (AD module
3100 automated traveling restart determination unit
3110 automated traveling determination unit
3111 traveling state management unit
3112 ignition state (IG-state) detection unit
3113 positioning state storage unit
3114 estimated vehicle azimuth detection unit
3120 automated traveling control unit
3121 destination detection unit
3122 target traveling path planning unit
3123 traveling start instruction detection unit
3131 stopped vehicle detection unit
3132 own-vehicle azimuth detection unit
3133 own-vehicle yaw angle calculation unit
3134 stopped-vehicle direction calculation unit
3135 stopped-vehicle first azimuth calculation unit
3136 stopped-vehicle second azimuth calculation unit
501 ignition-off (IG-OFF) state
502 manual traveling state
503 automated traveling state
504 minimum risk maneuver (MRM) state
505 emergency stop state
700 ground object
1001 calculation processing circuit
1002 storage device
1003 input/output circuit

What is claimed is:

1. An automated driving system comprising a vehicle having a target traveling path for performing automated traveling, the automated driving system being configured to acquire a position and an azimuth of the vehicle and a measurement reliability therefor, wherein
the vehicle includes an automated traveling restart determination circuitry to switch from a stopped state to automated traveling, and
in a case where the measurement reliability is equal to or greater than a predetermined first threshold,
restart of automated traveling of the vehicle is permitted when an absolute value of a first position deviation between the target traveling path and the position of the vehicle is equal to or smaller than a predetermined second threshold and an absolute value of an angle deviation between an azimuth of the target traveling path and the azimuth of the vehicle is equal to or smaller than a predetermined third threshold.

2. The automated driving system according to claim 1, wherein
the vehicle includes
an own-vehicle position detector to detect a position and an azimuth of the own vehicle and acquire a measurement reliability therefor, and
a positioning state storage to store the position and the azimuth of the own vehicle and the measurement reliability therefor acquired by the own-vehicle position detector at a time of finish of automated traveling, and
the automated traveling restart determination circuitry of the vehicle
calculates a second position deviation between the position of the own vehicle detected by the own-vehicle position detector before start of traveling and the position of the own vehicle at a last time of finish of automated traveling stored in the positioning state storage, and
in a case where the second position deviation is equal to or smaller than a predetermined fourth threshold, performs determination for restart of automated traveling of the vehicle, using the azimuth of the own vehicle and the measurement reliability therefor at the last time of finish of automated traveling stored in the positioning state storage.

3. The automated driving system according to claim 2, further comprising:
at least one roadside device to detect an obstacle and a traveling road surface in a field of view; and
an edge computer to output obstacle information including a position and an azimuth of the obstacle and a measurement reliability therefor acquired from the roadside device, to the vehicle, wherein
the automated traveling restart determination circuitry of the vehicle compares magnitudes of the measurement reliability at a time of acquisition of the position of the own vehicle detected by the own-vehicle position detector before start of traveling and the measurement reliability for the position of the own vehicle included in the obstacle information acquired from the edge computer, and performs determination for restart of automated traveling of the vehicle, using the position and the azimuth of the own vehicle associated with a greater one of the compared measurement reliabilities.

4. The automated driving system according to claim 3, wherein
the roadside device includes an optical sensor, and reflection points from the obstacle in the field of view are included as point-cloud data in the obstacle information, and
the edge computer includes
a first vehicle direction calculation circuitry to calculate a direction of a stopped vehicle on the basis of the obstacle information,
a first azimuth calculation circuitry to calculate an azimuth of a ground object fixed in the field of view on the basis of reflection points from the ground object in the obstacle information, and
a first vehicle azimuth calculation circuitry to calculate an azimuth of the stopped vehicle and a measurement reliability therefor, using the direction of the stopped vehicle calculated by the first vehicle direction calculation circuitry and the azimuth of the ground object calculated by the first azimuth calculation circuitry.

5. The automated driving system according to claim 4, wherein
in the obstacle information acquired from the roadside device, the measurement reliability is decreased with increase in a detection distance to the obstacle.

6. The automated driving system according to claim 3, wherein
the roadside device includes an image sensor, and white line information of a traveling road surface is included in the obstacle information, and
the edge computer includes
a second vehicle direction calculation circuitry to calculate a direction of a stopped vehicle on the basis of the obstacle information from the image sensor,
a second azimuth calculation circuitry to calculate a white line reference azimuth which is a direction of a road, from the white line information included in the obstacle information, and
a second vehicle azimuth calculation circuitry to calculate an azimuth of the stopped vehicle and a measurement reliability therefor, using the direction of the stopped vehicle calculated by the second vehicle direction calculation circuitry and the white line reference azimuth calculated by the second azimuth calculation circuitry.

7. The automated driving system according to claim 6, wherein
in the obstacle information acquired from the roadside device, the measurement reliability is decreased with increase in a detection distance to the obstacle.

8. The automated driving system according to claim 7, wherein
the measurement reliability is decreased in a case where a content rate of noise in an image acquired from the image sensor of the roadside device is equal to or greater than a predetermined noise threshold.

9. The automated driving system according to claim 3, comprising a plurality of the vehicles for performing automated traveling, wherein
each vehicle includes
an obstacle sensor to detect an obstacle around the own vehicle,
a stopped-vehicle direction calculation circuitry to detect, as a stopped vehicle, another vehicle that has stopped, from the obstacle detected by the obstacle sensor, and estimate a direction of the stopped vehicle, and
a stopped-vehicle first azimuth calculation circuitry to calculate an azimuth of the stopped vehicle, using the azimuth of the own vehicle and the reliability therefor acquired by the own-vehicle position detector and the estimated direction of the stopped vehicle, and
each vehicle transmits the azimuth of the stopped vehicle calculated by the stopped-vehicle first azimuth calculation circuitry, together with a position thereof and a measurement reliability therefor, to the edge computer.

10. The automated driving system according to claim 3, comprising a plurality of the vehicles for performing automated traveling, wherein
each vehicle includes
an obstacle sensor to detect an obstacle around the own vehicle,
a sensor to detect a yaw rate of the own vehicle,
a stopped-vehicle direction calculation circuitry to detect, as a stopped vehicle, another vehicle that has stopped, from the obstacle detected by the obstacle sensor, and estimate a direction of the stopped vehicle,
a yaw angle calculation circuitry to calculate an azimuth of the own vehicle from a yaw angle obtained by integrating the detected yaw rate, and
a stopped-vehicle second azimuth calculation circuitry to calculate an azimuth of the stopped vehicle, using the azimuth of the own vehicle calculated by the yaw angle circuitry and the estimated direction of the stopped vehicle, and
each vehicle transmits the azimuth of the stopped vehicle calculated by the stopped-vehicle second azimuth calculation circuitry, together with a position thereof and a measurement reliability therefor, to the edge computer.

11. The automated driving system according to claim 10, wherein
in a case where the measurement reliability for the position and the azimuth of the own vehicle detected by the own-vehicle position detector has become equal to or smaller than a predetermined threshold, the vehicle transmits, to the edge computer, the measurement reliability at that time and a position of the vehicle calculated by accumulating a movement distance acquired by a movement distance sensor provided to the vehicle.

12. The automated driving system according to claim 9, wherein
the automated traveling restart determination circuitry of the vehicle compares magnitudes of the measurement reliability at the time of acquisition of the position of the own vehicle detected by the own-vehicle position detector before start of traveling, the measurement reliability for the position of the own vehicle included in the obstacle information acquired from the edge computer, and the measurement reliability for the stopped vehicle acquired from the edge computer, and performs determination for restart of automated traveling of the vehicle, using the position and the azimuth of the own vehicle associated with a greatest one of the compared measurement reliabilities.

13. The automated driving system according to claim 10, wherein
the automated traveling restart determination circuitry of the vehicle compares magnitudes of the measurement reliability at the time of acquisition of the position of the own vehicle detected by the own-vehicle position detector before start of traveling, the measurement reliability for the position of the own vehicle included in the obstacle information acquired from the edge computer, and the measurement reliability for the stopped vehicle acquired from the edge computer, and performs determination for restart of automated traveling of the vehicle, using the position and the azimuth of the own vehicle associated with a greatest one of the compared measurement reliabilities.

14. The automated driving system according to claim 11, wherein
the automated traveling restart determination circuitry of the vehicle compares magnitudes of the measurement reliability at the time of acquisition of the position of the own vehicle detected by the own-vehicle position detector before start of traveling, the measurement reliability for the position of the own vehicle included in the obstacle information acquired from the edge computer, and the measurement reliability for the stopped vehicle acquired from the edge computer, and performs determination for restart of automated traveling of the vehicle, using the position and the azimuth of the own vehicle associated with a greatest one of the compared measurement reliabilities.

15. The automated driving system according to claim 1, wherein
the vehicle is a vehicle that performs following traveling above an electromagnetic guide wire installed at a road surface, and
the vehicle includes a guide sensor to detect a varying magnetic field from the electromagnetic guide wire, and map information including the electromagnetic guide wire.

16. The automated driving system according to claim 2, wherein
the vehicle is a vehicle that performs following traveling above an electromagnetic guide wire installed at a road surface, and
the vehicle includes a guide sensor to detect a varying magnetic field from the electromagnetic guide wire, and map information including the electromagnetic guide wire.

17. The automated driving system according to claim 3, wherein
the vehicle is a vehicle that performs following traveling above an electromagnetic guide wire installed at a road surface, and
the vehicle includes a guide sensor to detect a varying magnetic field from the electromagnetic guide wire, and map information including the electromagnetic guide wire.
